(19) United States
(12) Patent Application Publication
(10) Pub. No.: US 2017/0096130 A1
(43) Pub. Date: Apr. 6, 2017

(54) ASSEMBLY FOR A HYDRAULIC MOTOR-VEHICLE BRAKE SYSTEM AND BRAKE SYSTEM HAVING SUCH AN ASSEMBLY

(71) Applicant: Continental Teves AG & Co. oHG, Frankfurt (DE)

(72) Inventors: Stefan Drumm, Saulheim (DE); Marco Besier, Bad Schwalbach (DE)

(73) Assignee: Continental Teves AG & Co. oHG, Frankfurt (DE)

(21) Appl. No.: 15/383,355

(22) Filed: Dec. 19, 2016

Related U.S. Application Data
(63) Continuation of application No. PCT/EP2015/060171, filed on May 8, 2015.

(30) Foreign Application Priority Data
Jun. 30, 2014 (DE) 10 2014 212 538.3

(51) Int. Cl. B60T 8/40; B60T 8/36

(52) U.S. Cl. CPC B60T 8/4059; B60T 8/4081; B60T 8/405; B60T 8/3655

(57) ABSTRACT

The disclosure relates to an assembly for a hydraulic motor-vehicle brake system that includes a first port for connecting to a pressure chamber of a master brake cylinder and a second port for connecting to a pressure-medium reservoir. The assembly includes an output pressure port for connecting to a pressure modulation device and a pump assembly having at least a first suction side connected to the second port. In addition, the assembly includes a first hydraulic connection that connects the first port and the output pressure port. A first valve is arranged about the first hydraulic connection and is configured to be is open when current is not applied. The assembly includes a second hydraulic connection between the first port and the second port. A second valve is arranged about the second hydraulic connection, which is closed when current is not applied.

### CROSS REFERENCE TO RELATED APPLICATIONS

This U.S. patent application claims the benefit of PCT patent application No. PCT/EP2015/060171, filed May 8, 2015, which claims the benefit of German patent application No. 10 2014 212 538.3, filed Jun. 30, 2014, both of which are hereby incorporated by reference.

### TECHNICAL FIELD

The disclosure relates to an assembly for a hydraulic motor-vehicle brake system.

### BACKGROUND

International Patent Application WO 2012/150120 A1 discloses a hydraulic motor-vehicle brake system having a dual-circuit brake master cylinder that can be actuated by means of a brake pedal, an electrically controllable pressure modulation device for setting wheel-specific brake pressures and an electronically controllable pressure supply device having two pumps, and, in each brake circuit, a valve which is open when deenergized and controllable in an analog manner and a valve which is closed when deenergized and controllable in an analog manner. In this arrangement, one of the pumps is connected on the suction side to one of the pressure chambers of the brake master cylinder, and the other pump is connected on the suction side to the pressure medium reservoir. The pressure sides of the pumps of a brake circuit are connected together and form the corresponding output pressure port of the pressure supply device, which port is connected to the associated inlet valves. The analog valve of the pressure supply device that is closed when deenergized opens as soon as the pressure difference applied thereto reaches an opening pressure value determined by the design. This has the result that, when the brake pedal is actuated forcefully, pressure medium volume can flow out of the brake master cylinder into the pressure medium reservoir in some circumstances, causing the brake pedal to droop in a corresponding manner. This is a disadvantage of the previously known pressure supply device. Another disadvantage of this pressure supply device is that a standby mode, in which the pump is driven but no volume displacements between the first, second and third ports are performed, is not possible if the output pressure is higher than atmospheric pressure.

It is therefore an object of the present disclosure to provide an assembly having at least one pump and valves as well as a corresponding brake system which eliminates the last-mentioned disadvantage.

### SUMMARY

One aspect of the disclosure provides an assembly for a hydraulic motor-vehicle system. The assembly includes a first port for connecting to a pressure chamber of a brake cylinder and a second port for connecting to a pressure medium reservoir, such as, but not limited to, a pressure medium reservoir under atmospheric pressure. The assembly also includes an output pressure port, for example, for connecting to a pressure modulation device. The assembly includes a pump assembly, a first hydraulic connection, a second hydraulic connection, and first, second, and third valves. The pump assembly has at least one first suction side, which is connected to the second port by way of a line segment. The first hydraulic connection connects the first port and the output pressure port. The first valve is arranged about the first hydraulic connection. The first valve is configured to be open when deenergized and is controllable in an analog manner. , The second hydraulic connection connects. In addition, the second valve is configured to be closed when deenergized. The third valve is arranged between the first pressure side of the pump assembly and the first suction side. The third valve is configured to be open when deenergized and in controllable in an analog manner.

The disclosure offers the advantage that all that is necessary to produce a standby state with a high potential for a rapid pressure buildup is to drive the pump assembly, with no need to activate (energize) a valve. Here, the pump assembly delivers pressure medium virtually without a differential pressure, and this pressure medium is fed back from the first pressure side to the first suction side via the open third valve. For a rapid pressure buildup, all that is then necessary is to close the third valve, and the pressure buildup is not restricted by the need for the drive of the pump assembly to reach its rated speed first. Implementations of the disclosure may include one or more of the following optional features. In some implementations, in a passive (i.e. deenergized) mode of the assembly or brake system, an unhindered exchange of pressure medium volume between the first port (brake master cylinder) and the output pressure port (of the pressure modulation device) is possible via the open first valve, while an exchange of pressure medium volume between the first port (the brake master cylinder) and the second port (pressure medium reservoir) is prevented by the closed second valve.

In some examples, the output pressure port is connected to a pressure modulation device of the brake system.

In some implementations, no further valve is arranged in the connection containing the first valve between the first port and the output pressure port. Thus, in a passive (i.e. deenergized) mode of the assembly or brake system, an unhindered exchange of pressure medium volume is possible between the first port (the brake master cylinder) and the output pressure port (of the pressure modulation device).

To control a pressure intensification between the input pressure at the first port and the output pressure at the output pressure port, a first pressure detection device, which detects the pressure at the first port, and a second pressure detection device, which detects the pressure at the output pressure port, may be present.

The first suction side of the pump assembly may be connected to the second port directly, i.e., without the interposition of a valve, thus avoiding flow resistances during intake from the pressure medium reservoir.

In some examples, a check valve is connected to the first pressure side of the pump assembly. The check valve opens in the direction of the volume discharge of the pump assembly.

In some implementations, the pump assembly is formed by a single pump having the first suction side and the first pressure side. The volume discharge side of the check valve may be connected to the output pressure port. Thus, the first pressure side is connected to the output pressure port via the check valve. The assembly offers the advantage that just a single pump is needed (for each brake circuit). When the third valve is closed, pressure medium is pumped from the second port (pressure medium reservoir) to the output pressure port via the check valve by means of the pump. When the first valve is closed or partially closed, a pressure intensification at the output pressure port is achieved in this way. When the first valve is open or partially open, this enables pressure medium to be delivered from the second port (from the pressure medium reservoir) to the first port (to the brake master cylinder) via the check valve and the first valve in an electronically controlled manner. As a particularly preferred option, the pressure side is connected via the check valve directly to the third port, i.e. without the interposition of another valve.

In some example, the assembly includes a fourth valve designed to be open when deenergized and is controllable in an analog manner. The fourth valve may be arranged in the hydraulic connection between the first port and the second port and wherethe second valve is arranged. In some examples, the fourth valve is arranged in series with the second valve. In contrast to the direction of installation of the fourth valve, the direction of installation of the second valve may be chosen in such a way that pressurization of the first port leads to the valve tappet being pressed onto the valve seat. This offers the advantage that any pressure surges in the first port which may occur when the second valve is deenergized do not lead to unwanted outflow of pressure medium to the second port.

In some implementations, the pump assembly is formed by a first pump and a second pump. The first pump has the first suction side and the first pressure side, while the second pump has a second suction side and a second pressure side. This assembly offers the advantage of managing with just three electrically controllable valves.

The second pump may be connected in parallel with the first valve. The second suction side is connected to the first port and the second pressure side is connected to the output pressure port. It is thereby possible to achieve a pressure intensification at the output pressure port by means of the second pump when the first valve is closed or partially closed.

In some implementations, the pressure side of the first pump is connected to the first port by means of the second valve. When the second valve is open and the third valve is at least partially or temporarily closed, pressure medium may thus be pumped from the second port (i.e. out of the pressure medium reservoir) to the first port (i.e. into the brake master cylinder) in a controlled manner by means of the first pump without the need for pressure medium to flow via the first valve.

The volume discharge side of the check valve may be connected to the first port. Thus, the first pressure side is connected to the first port via the check valve. In some examples, the pressure side of the first pump is connected via the check valve directly to the first port, i.e., without the interposition of another valve.

In some implementations, the volume discharge side of the check valve is connected to the output pressure port. The pressure side of the first pump is thus connected to the output pressure port via the check valve. In this way, a more rapid pressure buildup may be achieved at the output pressure port since the volume flows of the first and of the second pump can be connected in parallel. In some examples, the pressure side of the first pump is connected via the check valve directly to the output pressure port, i.e., without the interposition of another valve.

A second check valve opening in the direction of the output pressure port may be connected in parallel with the first valve.

The second valve, which is closed when deenergized, and a valve (either the fourth valve or the third valve, depending on the example of the pump assembly) which is open when deenergized and controllable in an analog manner are preferably arranged in the hydraulic connection between the first port and the second port. As a particularly preferred option, no other valve is arranged in the connection.

In some examples, the assembly includes a first pressure detection device configured to detect the pressure at the first port and a second pressure detection device configured to detect the pressure at the output pressure port. In some implementations, the second valve includes a switching valve.

Another aspect of the disclosure relates to a brake system having at least one assembly for a hydraulic motor-vehicle system. In some implementations, the brake system includes a brake master cylinder actuable by means of a brake pedal and having pressure chambers. Each pressure chamber is assigned at least one wheel brake. The brake system also includes a pressure medium reservoir under atmospheric pressure assigned to the brake master cylinder. The brake system also includes an electrically controllable pressure modulation device for setting wheel-specific brake pressures. The electrically controllable pressure modulation device includes at least one inlet valve for each wheel brake and one outlet valve for each wheel brake. The brake system also includes an electrically controllable pump-valve assembly including an assembly for a hydraulic motor-vehicle brake system per pressure chamber. The assembly for a hydraulic motor-vehicle brake system having a first port connected to one of the pressure chambers, a second port connected to the pressure medium reservoir, and an output pressure port connected to the inlet valve assigned to the pressure chamber, The assembly for the hydraulic motor-vehicle brake includes a pump assembly, a first hydraulic connection, a second hydraulic connection, and first, second, and third valves. The pump assembly has at least one first suction side, which is connected to the second port by way of a line segment. The first hydraulic connection connects the first port and the output pressure port. The first valve is arranged about the first hydraulic connection. The first valve is configured to be open when deenergized and is controllable in an analog manner. The second hydraulic connection connects. In addition, the second valve is configured to be closed when deenergized. The third valve is arranged between the first pressure side of the pump assembly and the first suction side. The third valve is configured to be open when deenergized and in controllable in an analog manner.

In some implementations, the brake system includes a brake booster arranged upstream of the brake master cylinder. The brake system may include another electrically controllable pressure supply device that may be formed by a cylinder-piston assembly, the piston of which can be actuated by an electromechanical actuator. In some examples, in a “brake-by-wire” operating mode, the brake system may be controlled either by the vehicle driver or independently of the vehicle driver. The brake system may further include a first electronic open-loop and closed-loop control unit, assigned to the pressure supply device and the pressure modulation device (150), and a second electronic open-loop and closed-loop control unit (145), assigned to the pump-valve assembly (160.

In some implementations, the brake system includes a simulation device, which can be connected hydraulically to at least one pressure chamber of the brake master cylinder by means of an electrically actuable simulator enable valve and which gives the vehicle driver a pleasant brake pedal feel in a “brake-by-wire” operating mode.

Each brake circuit supply line connecting the inlet valves of a brake circuit is preferably connected via a hydraulic connecting line containing an isolating valve that is open when deenergized to the output pressure port of the assembly and, via another hydraulic connecting line containing a sequence valve that is closed when deenergized, to the pressure supply device.

A first electronic open-loop and closed-loop control unit, assigned to the pressure supply device and the pressure modulation device, and a second electronic open-loop and closed-loop control unit, assigned to the pump-valve assembly, are preferably provided.

The details of one or more implementations of the disclosure are set forth in the accompanying drawings and the description below. Other aspects, features, and advantages will be apparent from the description and drawings, and from the claims.

### DESCRIPTION OF DRAWINGS

Further preferred examples of the disclosure will become apparent from the dependent claims and the following description with reference to figures, of which:

FIG. 1 is a schematic view of an exemplary assembly for a hydraulic motor-vehicle brake system,

FIG. 2 is a schematic view of another exemplary assembly for a hydraulic motor-vehicle brake system,

FIG. 3 is a schematic view of yet another exemplary assembly for a hydraulic motor-vehicle brake system,

FIG. 4 is a schematic view of another exemplary assembly for a hydraulic motor-vehicle brake system,

FIG. 5 is a schematic view of an exemplary brake system,

FIG. 6 is a schematic view of another exemplary brake system, and

FIG. 7 is a schematic view of yet another exemplary brake system.

### DETAILED DESCRIPTION

FIG. 1 shows an assembly according to the disclosure for a hydraulic motor-vehicle brake system. The assembly includes a first port 1 for connecting to a pressure chamber of a brake master cylinder, a second port 2 for connecting to a pressure medium reservoir, advantageously a pressure medium reservoir under atmospheric pressure, and an output pressure port 3 for connecting to a pressure modulation device. The assembly according to the example includes a pump assembly 4 and four electrically controllable valves 5, 6, 7, 8.

The first valve 5 (pressure raising valve), which is designed to be open when deenergized and to be controllable in an analog manner, is arranged in a hydraulic connection 11 (e.g., first hydraulic connection) between the first port 1 and the output pressure port 3. The first valve includes line segments 11a and 11b. A check valve 10 opening in the direction of the output pressure port 3 is connected in parallel with the first valve 5.

Arranged in series in another hydraulic connection 12 (e.g., second hydraulic connection), which connects the first port 1 to the second port 2, are the second valve 6 (brake master cylinder reduction enable valve) and the fourth valve 7 (brake master cylinder reduction metering valve). The second hydraulic connection 12 includes line segments 11a, 12a and 12b. The second valve 6 is designed to be closed when deenergized, the fourth valve 7 is designed to be open when deenergized and to be controllable in an analog manner, where, from the direction of the first port 1, the second valve 6 is arranged first, followed by the third valve 8.

According to the example, the pump assembly 4 is formed by a single pump 50 driven by an electric motor M and having a suction side 41 and a pressure side 42. Connected in parallel with the pump 50 is the third valve 8 (backpressure valve), which is designed to be open when deenergized and to be controllable in an analog manner. The suction side 41 of the pump and one port of the third valve 8 are connected by line segment 12b to the second port 2. The suction side 41 of the pump assembly 4 is connected to the second port 2 directly, i.e., without the interposition of a valve. The pressure side 42 of the pump and the other port of the third valve 8 are connected via line segment 15 and a check valve 9 that opens in the direction of the output pressure port to line segment 11b and thus to the output pressure port 3. When the first valve 5 is open, the pressure side 42 of the pump assembly 4 is thus connected to the first port 1, where the check valve 9 opening in the direction of the first port is arranged in this connection.

By means of the assembly according to the example, a pressure input at the first port 1 can be raised or intensified to predetermined values of the pressure at the output pressure port 3. For this purpose, the first valve 5 is partially or completely closed, the third valve 8 is completely closed and the pump 50 is driven, for example. A pressure difference across the first valve 5 is established, and this difference can be adjusted to a desired value by appropriate open-loop/closed-loop control of the first valve 5. The pressure medium is drawn in from the pressure medium reservoir via the second port 2.

By optional opening of the second valve 6 and, if appropriate, closed-loop control of the fourth valve 7, it is also possible to take pressure medium from the brake master cylinder.

For closed-loop control of a pressure intensification between the input pressure at the first port 1 and the output pressure at the output pressure port 3, a first pressure detection device 20, which detects the pressure at the first port 1, and a second pressure detection device 21, which detects the pressure at the output pressure port 3, are provided.

By means of the assembly according to the example, the pressure medium volume of the brake master cylinder can be changed.

For controlled discharge of pressure medium from the brake master cylinder (first port 1), the second valve 6 is opened and, under the control of the fourth valve 7, pressure medium is discharged via the second port 2 into the pressure medium reservoir.

To deliver pressure medium from the pressure medium reservoir (from the second port 2) into the brake master cylinder (to the first port 1), the third valve 8 is closed and pressure medium is pumped by means of the pump assembly 4 from the second port 2, via the check valve 9 and the first valve 5, which is open or opened in a controlled manner, to the first port 1.

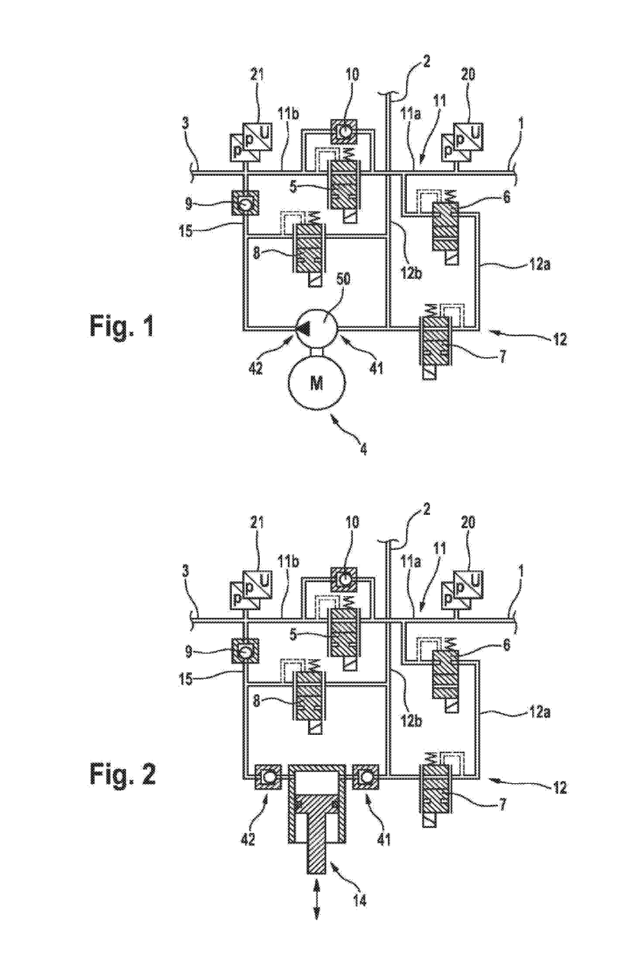

FIG. 2 illustrates another exemplary assembly according to the disclosure, which corresponds to the first example shown in FIG. 1 as regards the four valves 5, 6, 7, 8 and the two pressure detection devices 20, 21 as well as the arrangement and hydraulic connections thereof. According to the second illustrative example, a pump assembly 14 is provided which is formed by a piston pump with correspondingly arranged check valves (not denoted specifically) for the suction and pressure sides.

All pumps of the “pressure medium volume displacer” type, e.g. gear pumps or piston pumps, are suitable as types of pump for the assembly according to the disclosure. The intake of the pumps is advantageously taken directly and without restriction from the second port 2.

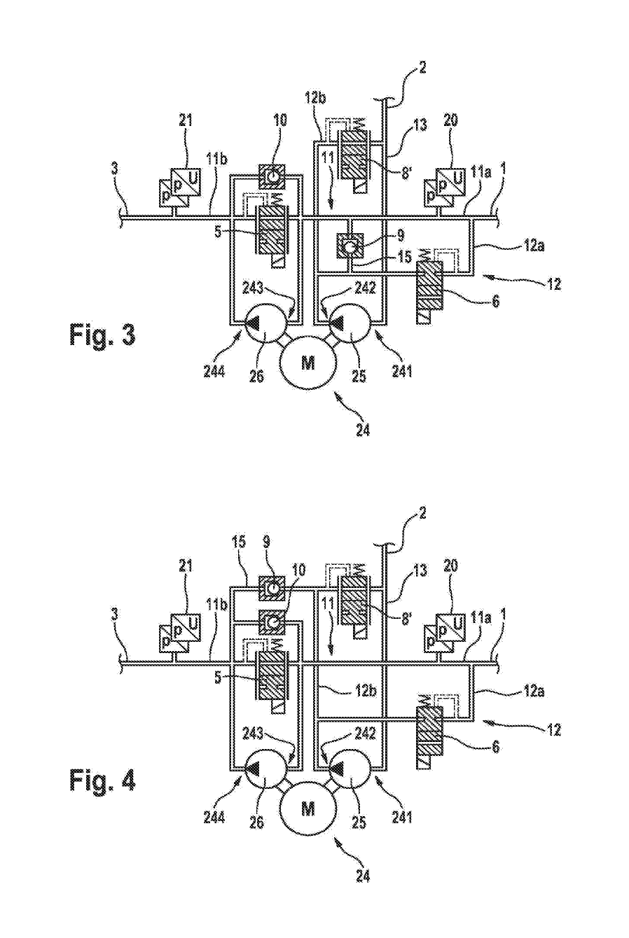

FIG. 3 shows a third illustrative example of an assembly according to the disclosure for a hydraulic motor-vehicle brake system. The assembly includes a first port 1 for connecting to a pressure chamber of a brake master cylinder, a second port 2 for connecting to a pressure medium reservoir, advantageously a pressure medium reservoir under atmospheric pressure, and an output pressure port 3 for connecting to a pressure modulation device. The assembly according to the example includes a pump assembly 24 and three electrically controllable valves 5, 6, 8′.

The first valve 5 (pressure raising valve), which is designed to be open when deenergized and to be controllable in an analog manner, is arranged in a first hydraulic connection 11 between the first port 1 and the output pressure port 3, including line segments 11a and 11b. A check valve 10 opening in the direction of the output pressure port 3 is connected in parallel with the first valve 5.

Arranged in series in second hydraulic connection 12, which connects the first port 1 to the second port 2, are the second valve 6 and the third valve 8′. The second hydraulic connection 12 includes line segments 11a, 12a and 12b. The second valve 6 is designed to be closed when deenergized, the third valve 8′ is designed to be open when deenergized and to be controllable in an analog manner, where, from the direction of the first port 1, the second valve 6 is arranged first, followed by the third valve 8′.

A first pressure detection device 20, which detects the pressure at the first port 1, and a second pressure detection device 21, which detects the pressure at the output pressure port 3, are provided.

According to the example, the pump assembly 24 is formed by two pumps 25, 26, which are driven jointly by an electric motor M.

The second pump 26 is connected in parallel with the first valve 5, i.e., the suction side 243 of the second pump 26 (second suction side 243 of the pump assembly 24) is connected to the first port 1, and the pressure side 244 of the second pump 26 (second pressure side 244 of the pump assembly 24) is connected to the output pressure port 3. In this case, the two connections mentioned are embodied in a direct way, i.e., without the interposition of a valve.

The suction side 241 of the first pump 25 (first suction side 241 of the pump assembly 24) is connected, advantageously directly, to the second port 2 via line segment 13, and the pressure side 242 of the first pump 25 (first pressure side 242 of the pump assembly 24) is connected to line segment 12b between the second and the third valve 8, 8′, i.e. the first pressure side 242 is connected via the third valve 8′ to the second port 2 in a manner which allows hydraulic restriction. The third valve 8′ is thus arranged in parallel with the first pump 25.

Line segment 12b is, in turn, connected via a check valve 9 (in line segment 15) opening in the direction of the first port 1 to line segment 11a and thus to the first port 1. Thus, the first pressure side 242 of the pump assembly 24 is connected to the first port 1, where the check valve 9 opening in the direction of the first port is arranged in the connection.

By means of the assembly according to the example, a pressure input at the first port 1 may be raised or intensified to predetermined values of the pressure at the output pressure port 3, while maintaining the volume balance. For this purpose, the first valve 5 is partially or completely closed and pump 26 is driven. A pressure difference across the first valve 5 is established, and this difference can be adjusted to a desired value by appropriate open-loop/closed-loop control of the first valve 5. As a result, pressure medium is delivered from the first port 1 to the output pressure port 3 without the occurrence of a volume exchange via the second port 2. In the event that it is necessary to change the volume balance during the operation of the brake system, pressure medium is drawn in from the pressure medium reservoir by the first pump 25 via the second port 2 and pumped via the check valve 9 into line segment 11a to increase the volume, and, to reduce the volume, the second valve 6 is opened and the third valve 8′ is partially or completely opened, as a result of which pressure medium flows off to the reservoir.

By means of this assembly according to the example too, the pressure medium volume of the brake master cylinder can be changed.

For controlled discharge of pressure medium from the brake master cylinder (first port 1), the second valve 6 is opened and, under the control of the third valve 8′, pressure medium is discharged via the second port 2 into the pressure medium reservoir.

To deliver pressure medium from the pressure medium reservoir (from the second port 2) into the brake master cylinder (to the first port 1), the third valve 8′ is closed and pressure medium is pumped by means of the first pump 25 of pump assembly 24 from the second port 2, via the check valve 9, to the first port 1.

In the illustrative example shown in FIG. 3, with separate pumps 25, 26 for pressure intensification at the output pressure port 3 (pump 25) and for influencing the pressure medium volume in the brake master cylinder (pump 26), the function of pumping pressure medium out of the pressure medium reservoir into the brake master cylinder can be achieved without the hydraulic path via the output pressure port 3 and the first valve 5 (as in the first illustrative example).

For this pump assembly 24 of the third illustrative example, the third valve 8′ in a certain way combines the functionalities of the third and fourth valve 8, 7 of the first illustrative example.

FIG. 4 shows a fourth illustrative example of an assembly according to the disclosure, which includes a pump assembly 24 and three electrically controllable valves 5, 6, 8′, which are connected to one another essentially as in the third illustrative example. In contrast to the third illustrative example, line segment 12b is connected via the check valve 9 (in line segment 15) to line segment 11b and thus to the output pressure port 3. Check valve 9 is designed to open in the direction of the output pressure port 3. Thus, the first pressure side 242 of the pump assembly 24 is connected to the output pressure port 3, where the check valve 9 opening in the direction of the output pressure port 3 and hence in the direction of the first port 1 is arranged in the connection. This illustrative example offers the advantage that the delivery volume flows of the two pumps 25, 26 are connected together for a rapid pressure buildup at the output pressure port 3.

Common to the assemblies according to the disclosure in FIGS. 1 to 4 is the fact that, in a passive (i.e. deenergized) mode of the assembly or brake system, an unhindered exchange of pressure medium volume between the first port 1 (the brake master cylinder) and the output pressure port 3 (the pressure modulation device) is possible via the open first valve 5, while an exchange of pressure medium volume between the first port 1 (the brake master cylinder) and the second port 2 (pressure medium reservoir) is prevented by the closed second valve 6.

It is furthermore possible, in the assemblies according to the examples, for the output pressure at the output pressure port 3 to be raised to freely specifiable values above the input pressure at the first port 1 (brake master cylinder pressure) and for the pressure medium volume of the brake master cylinder to be changed in an active mode. The change can be accomplished by controlled discharge of pressure medium from the brake master cylinder into the pressure medium reservoir or by controlled pumping of pressure medium volume from the pressure medium reservoir into the brake master cylinder.

The assemblies according to the examples also permit an energy-saving standby mode, in which the pump assembly 4 or 24 is already being driven but no significant pump pressure is yet being built up on the first pressure side 42 or 242 since the valve 8 or valves 5 and 8′ are not yet being energized.

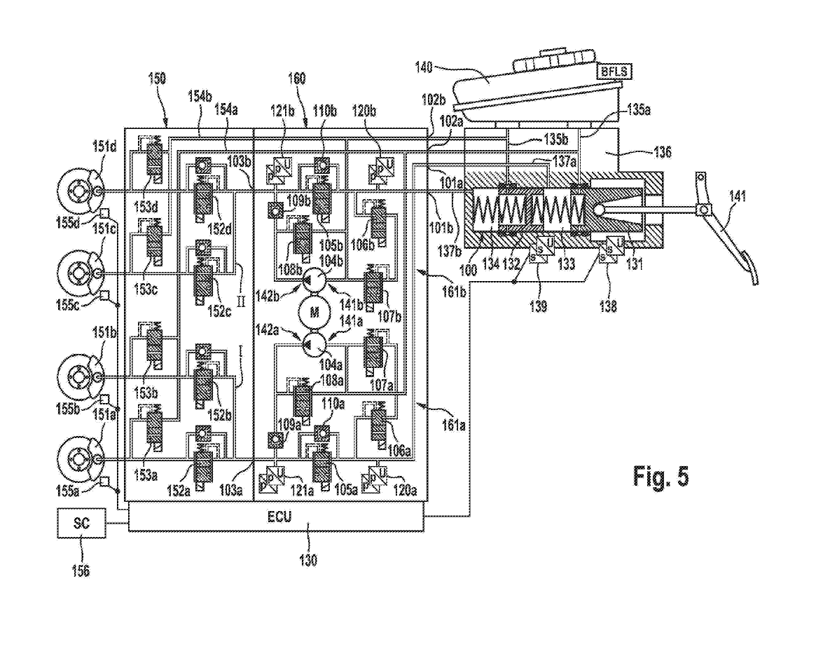

The first illustrative example, shown schematically in FIG. 5, of a brake system according to the disclosure essentially includes a brake master cylinder 100, which can be actuated directly by means of a brake pedal 141 via a push rod, a pressure medium reservoir 140 under atmospheric pressure assigned to the brake master cylinder 100, an electrically controllable pump-valve assembly 160, an electrically controllable pressure modulation device 150 for setting wheel-specific brake pressures for the wheel brakes 151a-151d of a motor vehicle (not shown), and an electronic open-loop and closed-loop control unit (ECU: electronic control unit) 130, which is used to control the pump-valve assembly 160 and the pressure modulation device 150.

The dual-circuit brake master cylinder 100 includes two pistons 131, 132 arranged in series, which delimit two hydraulic pressure chambers 133, 134. The first piston 131 is coupled mechanically to the brake pedal 141 and is actuated directly by the vehicle driver without the interposition of a brake booster. The pressure chambers 133, 134 are connected, on the one hand, to the pressure medium reservoir 140 via radial bores formed in the pistons 131, 132 and via corresponding pressure compensation lines 135a, 135b, where these lines can be shut off by a relative movement of the pistons 131, 132 in the housing 136. On the other hand, each of the pressure chambers 133 and 134 is connected by means of a hydraulic connection 137a and 137b, respectively, to a first port 101a, 101b of the pump-valve assembly 160. The pressure chambers 133, 134 accommodate return springs (not denoted specifically), which position the pistons 131, 132 in an initial position when the brake master cylinder 100 is unactuated.

To detect an actuation of the brake master cylinder 100, two independent displacement sensors 138 and 139 (i.e., travel sensors) are advantageously provided. The sensors detecting a displacement of the pistons 131 and 132, for example, and their signals being transmitted via a signal or data line to the electronic open-loop and closed-loop control unit 130.

For each circuit 137a, 137b of the brake master cylinder 110, the pump-valve assembly 160 includes a first port 101a, 101b, which is connected to the associated pressure chamber 133, 134, a second port 102a, 102b, which is connected to the pressure medium reservoir 140, and an output pressure port 103a, 103b, which is connected to the pressure modulation device 150.

According to the example, pressure modulation device 150 includes, for each wheel brake 151a-151d, an inlet valve 152a-152d and an outlet valve 153a-153d, which are connected together hydraulically in pairs via center ports and are connected to the wheel brake 151a-151d. The input ports of the inlet valves 152a-152d are supplied with a pressure for each brake circuit I, II via the output pressure ports 103a, 103b of the pump-valve assembly 160. Connected in parallel with each of the inlet valves 152a-152d is a check valve (not denoted specifically) opening to the pump-valve assembly 160. In each brake circuit, the output ports of the outlet valves 153a, 153b, 153c, 153d are connected by an associated return line 154a, 154b to the pump-valve assembly 160 and further, via the respective second port 102a, 102b, to the pressure medium reservoir 140. A different arrangement of valves in the pressure modulation device 150 is possible, in principle.

For each brake circuit 137a, 137b or I, II, the pump-valve assembly 160 includes an assembly 161a, 161b corresponding to the assembly according to the example in FIG. 1, i.e., with a pump 104a, 104b having a first suction side 141a, 141b and a first pressure side 142a, 142b, a first electrically actuable valve (pressure raising valve) 105a, 105, a second electrically actuable valve 106a, 106b (master cylinder reduction enable valve), a third electrically actuable valve 108a, 108b (backpressure valve), a fourth electrically actuable valve 107a, 107b (brake master cylinder reduction metering valve), a check valve 109a, 109b on the pump pressure side, a check valve 110a, 110b connected in parallel with the first valve, and two pressure sensors 120a, 121a and 120b, 121b, respectively.

The construction and operation of the assembly 161a, 161b according to the example has already been explained above, corresponding to the description of FIG. 1, and will therefore not be repeated again.

According to the example, the two pumps 104a and 104b are driven jointly by an electric motor M.

In order to be able to carry out an antilock control operation (ABS: antilock brake system), the brake system includes a wheel speed sensor 155a-155d for each wheel of the motor vehicle according to the example. The signals from the wheel speed sensors 155a-155d are fed to the open-loop and closed-loop control unit 130, and the wheel speed sensors 155a-155d are advantageously supplied with electric power by the open-loop and closed-loop control unit 130.

In order to be able to carry out an electronic stability control operation (ESC: electronic stability control) or a stabilizing assistance function, the brake system furthermore includes, according to the example, a sensor device 156 for detecting variables relating to driving dynamics and the steering angle or steering wheel angle, the signals of which are fed via a signal or data line to the open-loop and closed-loop control unit 130. Sensor device 156 is advantageously supplied with electric power by the open-loop and closed-loop control unit 130.

According to the example, sensor device 156 includes a sensor for detecting the yaw rate of the motor vehicle and a sensor for detecting the transverse acceleration of the motor vehicle. It is advantageous if sensor device 156 also includes a sensor for detecting the longitudinal acceleration of the motor vehicle. Moreover, the sensor device includes at least one sensor for detecting the vehicle steering state, that is to say, for example, the steering angle (wheel lock angle) or the steering wheel angle coupled therewith.

The brake system according to the first illustrative example manages without a brake booster arranged between the brake pedal and the brake master cylinder since the two circuit pressures (input pressures) output by the brake master cylinder 100 actuated by the brake pedal without boosting may be intensified by means of the pump-valve assembly 160 before they are output to the inlet valves 152a-152d of the pressure modulation device 150. The pressure intensifier (i.e. the pump-valve assembly 160 or assembly 161a, 161b) is constructed in such a way that it can not only raise the input pressure level to higher output pressure levels but is furthermore also capable of actively building up and reducing the pressure medium volume in the brake master cylinder. This function is required, for example, for recuperative braking operations.

The brake system according to the example combines a simple construction with peripheral functions—i.e. pressure intensification, recuperative braking, active braking, influencing the pedal travel, and ABS, ESC and ACC functionality (ACC: active cruise control).

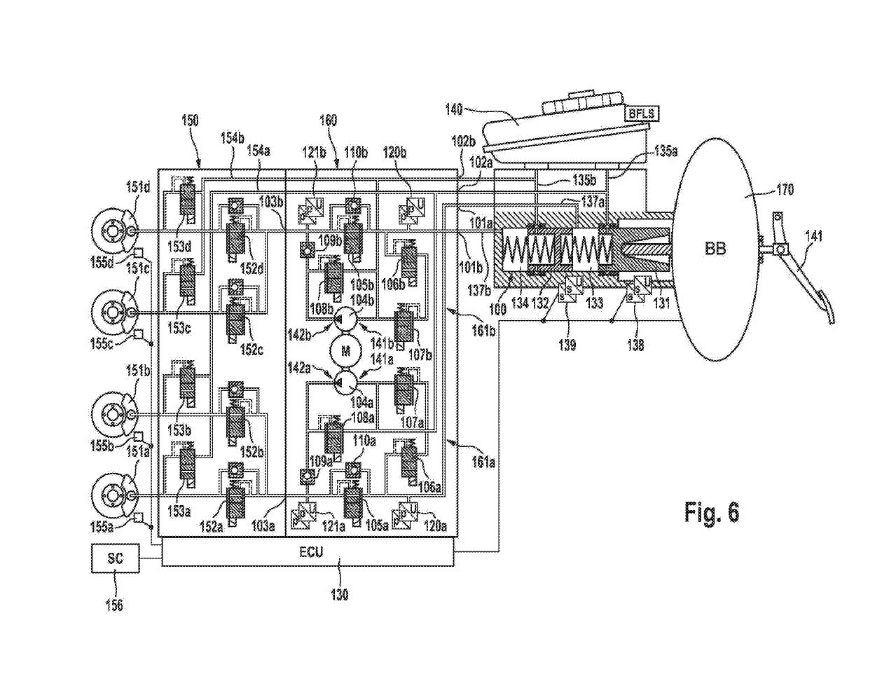

The second illustrative example of a brake system according to the disclosure, which is shown schematically in FIG. 6, corresponds to the first illustrative example in terms of the construction of the brake master cylinder 100, the pressure medium reservoir 140, the pump-valve assembly 160, the pressure modulation device 150 and the electronic open-loop and closed-loop control unit 130, while, as an addition to the first illustrative example, a brake booster 170 is arranged upstream of the brake master cylinder 100. The brake booster can be a vacuum brake booster, a hydraulic or an electric brake booster. When the pump-valve assembly 160 is inactive, the brake system thus forms a power-assisted brake system, even if the pump-valve assembly according to the disclosure can also be characterized by the fact that it is capable of providing a “power-assisted brake” while maintaining the volume balance as a “power-operated brake” with pressures and volume displacements determined “independently of the driver”—i.e. not directly by the driver by means of the brake pedal.

To carry out a recuperative braking operation, a pressure buildup in the wheel brakes 101a-151d is prevented or reduced with the aid of the inlet valves 152a-152d of the pressure modulation device 150 when the brake pedal is actuated. The braking action is taken over completely or partially by the vehicle drive. In order to maintain the accustomed brake pedal feel despite the reduced pressure medium volume for the wheel brakes, the pump-valve assembly 160 having one of the assemblies 161a, 161b according to the example is used, which, as already mentioned, enable the volume in the brake master cylinder to be influenced.

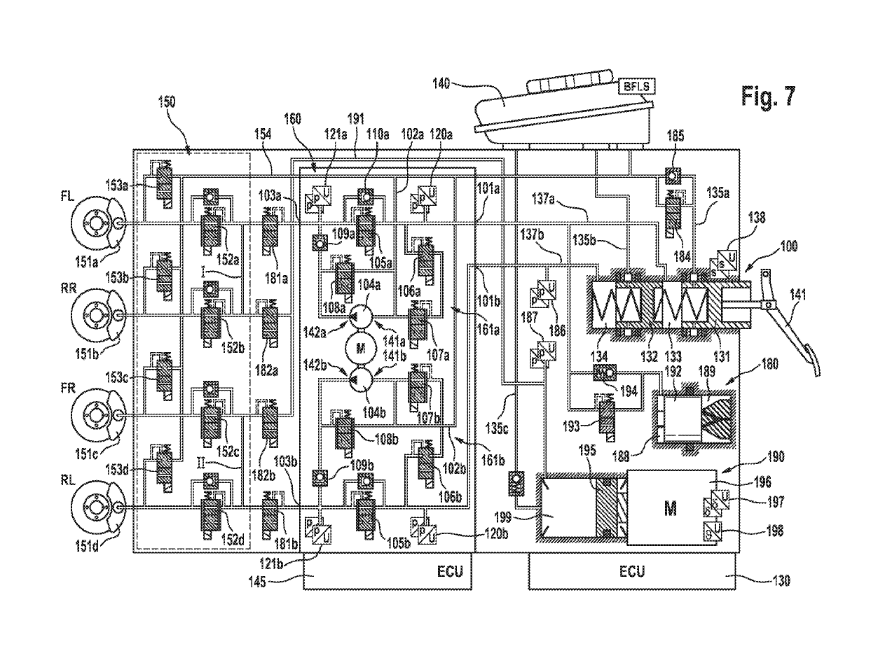

The third illustrative example of a brake system according to the disclosure is shown schematically in FIG. 7. The break system includes a simulator brake system essentially having a brake master cylinder 100, which can be actuated directly by means of a brake pedal 141 via a push rod, a pressure medium reservoir 140 under atmospheric pressure assigned to the brake master cylinder 100, a (travel) simulation device 180 interacting with the brake master cylinder 100, an electrically controllable pressure supply device 190, an electrically controllable pressure modulation device 150 for setting wheel-specific brake pressures for the wheel brakes 151a-151d, and a first electronic open-loop and closed-loop control unit 130, which is designed for controlling the pressure supply device 190 and the pressure modulation device 150, and having an electrically controllable pump-valve assembly 160 as an additional module, which contains an assembly 161a, 161b according to the example in each circuit and to which a second electronic open-loop and closed-loop control unit 145 is assigned.

Pressure modulation device 150 corresponds essentially to the pressure modulation device of the first illustrative example with wheel-specific inlet valves 152a-152d and outlet valves 153a-153d.

The input ports of the inlet valves 152a-152d are supplied by means of brake circuit supply lines I, II with pressures which, in a first operating mode (e.g. “brake-by-wire”), are derived from a system pressure present in a system pressure line 191 connected to the pressure supply device 190. The hydraulic connection between the system pressure line 191 and the brake circuit supply line I, II can be divided in each brake circuit by means of a sequence valve 182a, 182b, which is advantageously closed when deenergized. In a second operating mode (e.g. a boosted fallback mode), the brake circuit supply lines I, II are connected in each brake circuit to the output pressure ports 103a, 103b of assemblies 161a, 161b by means of an isolating valve 181a, 181b, which is advantageously open when deenergized. The output ports of the outlet valves 153a-153d are connected to the pressure medium reservoir 140 by a common return line 154.

According to the example, wheel brakes 151a and 151b are assigned to the front left-hand wheel FL and to the rear right-hand wheel RR and brake circuit supply line I, and wheel brakes 151c and 151d are assigned to the front right-hand wheel FR and the rear left-hand wheel RL and brake circuit supply line II. Different ways of dividing the brake circuits are conceivable.

The dual-circuit brake master cylinder 100 includes two pistons 131, 132 arranged in series, which delimit two hydraulic pressure chambers 133, 134. The first piston 131 is coupled mechanically to the brake pedal 141 and is actuated directly by the vehicle driver without the interposition of a brake booster. As in the first illustrative example in FIG. 3, the pressure chambers 133, 134 are assigned pressure compensation lines 135a, 135b leading to the pressure medium reservoir 140. Likewise, each of the pressure chambers 133, 134 is connected by means of a hydraulic connection 137a and 137b, respectively, to the first port 101a, 101b of the pump-valve assembly 160 or assembly 161a, 161b.

Pressure compensation line 135a contains a diagnostic valve 184, which is open when deenergized (NO), connected in parallel with a check valve 185 closing in the direction of the pressure medium reservoir 140.

To detect an actuation of the brake master cylinder 100, there is a travel sensor 138, advantageously of redundant design, which detects a displacement of the piston 131 and/or 132, for example.

A pressure sensor 186 connected to line segment 137b detects the pressure built up in pressure chamber 134 by a displacement of the second piston 132.

Simulation device 180 can be coupled hydraulically to the brake master cylinder 100 and essentially includes a simulator chamber 188, a simulator spring chamber 189 and a simulator piston 192 separating the two chambers from one another. Simulator piston 192 is supported on the housing by an elastic element (e.g. a spring), which is arranged in simulator spring chamber 188 and which is advantageously preloaded. The simulator chamber 188 can be connected to a pressure chamber 133 of the brake master cylinder 100 by means of an electrically actuable simulator enable valve 193. When a pedal force is input and the simulator enable valve 193 is activated, pressure medium flows from brake master cylinder pressure chamber 133 into the simulator chamber 188. A check valve 194 arranged hydraulically antiparallel with the simulator enable valve 193 allows a largely unhindered return flow of the pressure medium from the simulator chamber 188 to brake master cylinder pressure chamber 133, irrespective of the operating state of the simulator enable valve 193.

The electrically controllable pressure supply device 190 is designed as a hydraulic cylinder-piston assembly or a single-circuit electrohydraulic actuator, the piston 195 of which can be actuated by a schematically indicated electric motor 196 via a rotation-translation mechanism, likewise shown schematically. A rotor position sensor, which is used to detect the rotor position of the electric motor 196 and is indicated only schematically, is denoted by reference sign 197. In addition, a temperature sensor 198 can also be used to detect the temperature of the motor winding. The piston 195 delimits a pressure chamber 199, which is connected to the system pressure line 191. Additional pressure medium can be drawn into pressure chamber 199 by retracting the piston 195 with the sequence valves 182a, 182b closed, allowing pressure medium to flow out of the reservoir 140 into the actuator pressure chamber 199 via a replenishing line 135c containing a check valve (not denoted specifically) opening in the direction of flow to the actuator 190. To detect the pressure prevailing in the system pressure line 191, a pressure sensor 187 is provided, the sensor preferably being of redundant design.

For each brake circuit 137a, 137b or I, II, the pump-valve assembly 160 includes an assembly 161a, 161b, which corresponds to the assembly according to the example in FIG. 1, i.e. with a pump 104a, 104b having a first suction side 141a, 141b and a first pressure side 142a, 142b, a first electrically actuable valve (pressure raising valve) 105a, 105, a second electrically actuable valve 106a, 106b (master cylinder reduction enable valve), a third electrically actuable valve 108a, 108b (backpressure valve), a fourth electrically actuable valve 107a, 107b (brake master cylinder reduction metering valve), a check valve 109a, 109b on the pump pressure side, a check valve 110a, 110b connected in parallel with the first valve, and two pressure sensors 120a, 121a and 120b, 121b, respectively.

For each circuit 137a, 137b, the pump-valve assembly 160 includes the first port 101a, 101b, which is connected to the associated pressure chamber 133, 134, and the output pressure port 103a, 103b, which is connected to the pressure modulation device 150 via the isolating valve 181a, 181b. The second ports 102a, 102b of the assemblies 161a, 161b are connected to the return line 154 and thus to the pressure medium reservoir 140.

According to the example, the hydraulic components of the brake system are arranged in a hydraulic unit, where the pump-valve assembly 160 forms a submodule.

By using the pump-valve assembly 160, it is possible to dispense with a replenishment cycle of the pressure supply device 190. To refill the pressure chamber 199 of the pressure supply device 190, a high pressure is built up at at least one of the output pressure ports 103a, 103b of the assemblies 161a, 161b with the aid of the pump assembly (assemblies). The corresponding isolating valve 181a, 181b is then opened, as a result of which pressure medium flows into pressure chamber 199 via the opened sequence valve 182a, 182b. In this way, it is possible to replace pressure medium which has been discharged to the pressure medium reservoir 140 via the outlet valves 153a-153d by wheel brake pressure control activities by using the pump-valve assembly 160 to pump an equivalent pressure medium volume from the pressure medium reservoir into pressure chamber 199. In contrast to a corresponding simulator brake system without a pump-valve assembly 160, this allows uninterrupted ABS and stability control.

Operation of the simulator brake system with pump-valve assembly 160 is particularly safe because the full functioning of the brake system can be maintained by means of the pump-valve assembly 160 if the pressure supply device 190 fails. In the case of a leak too—e.g. in a wheel brake line—it is advantageous to switch over to operation by means of the pump-valve assembly 160 because this assembly is of dual-circuit design, thus enabling the brake circuit which is not affected by the leak to continue to be used in full. Moreover, the pump-valve assembly 160 provides the technical prerequisites for actively influencing the brake pedal 141, which is possible to only a very limited extent with a corresponding simulator brake system without a pump-valve assembly 160.

The pump-valve assembly in the illustrative example in FIG. 5, which is designed as an additional module, is largely the same as the pump-valve assembly in the brake system proposed in FIG. 4. This results in advantages as regards the development and production of brake systems.

A number of implementations have been described. Nevertheless, it will be understood that various modifications may be made without departing from the spirit and scope of the disclosure. Accordingly, other implementations are within the scope of the following claims.

What is claimed is:

1. An assembly for a hydraulic motor-vehicle brake system, having a first port for connecting to a pressure chamber of a brake master cylinder, a second port for connecting to a pressure medium reservoir, and an output pressure port for connecting to a pressure modulation device, the assembly comprising:
a pump assembly having at least one first suction side connected by way of a line segment to the second port and at least one first pressure side assigned to the first suction side;
a first hydraulic connection connects the first port and the output pressure port;
a first valve arranged about the first hydraulic connection, the first valve configured to be open when deenergized and is controllable in an analog manner; and
a second hydraulic connection connects the first port and the second port;
a second valve arranged about the second hydraulic connection, the second valve configured to be closed when deenergized; and
a third valve arranged between the first pressure side of the pump assembly and the first suction side, the third valve is configured to be open when deenergized and is controllable in an analog manner.

2. The assembly of claim 1, further comprising a check valve is connected to the first pressure side of the pump assembly, the check valve opening in a direction of a volume discharge of the pump assembly.

3. The assembly of claim 2, wherein the pump assembly is formed by a single pump having the first suction side and the first pressure side, wherein the side of the volume discharge of the check valve is connected to the output pressure port.

4. The assembly of claim 3, further comprising a fourth valve designed to be open when deenergized and is controllable in an analog manner, the fourth valve arranged in the second hydraulic connection between the first port and the second port where the second valve is arranged, the fourth valve is arranged in series with the second valve.

5. The assembly of claim 2, wherein the pump assembly comprises a first pump having the first suction side and the first pressure side and a second pump having a second suction side and a second pressure side.

6. The assembly of claim 5, wherein the second pump is connected in parallel with the first valve, the second suction side is connected to the first port and the second pressure side is connected to the output pressure port.

7. The assembly of claim 5, wherein the first port is connected to the first pressure side by means of the second valve.

8. The assembly of claim 5, wherein a side of the volume discharge of the check valve is connected to the first port.

9. The assembly of claim 5, wherein a side of the volume discharge of the check valve is connected to the output pressure port.

10. The assembly as of claim 1, further comprising:
a first pressure detection device configured to detect the pressure at the first port; and
a second pressure detection device configured to detect the pressure at the output pressure port.

11. The assembly of claim 1, wherein the second valve includes switching valve.

12. A brake system for a motor vehicle for actuating hydraulically actuable wheel brakes, the brake system comprising:
a brake master cylinder actuable by means of a brake pedal and having pressure chambers, wherein each pressure chamber is assigned at least one wheel brake;
a pressure medium reservoir under atmospheric pressure assigned to the brake master cylinder;
an electrically controllable pressure modulation device for setting wheel-specific brake pressures, having at least one inlet valve and one outlet valve for each wheel brake; and
an electrically controllable pump-valve assembly comprising an assembly for a hydraulic motor-vehicle brake system per pressure chamber, having a first port connected to one of the pressure chambers, a second port connected to the pressure medium reservoir, and an output pressure port connected to the inlet valve assigned to the pressure chamber, the assembly comprising:
a pump assembly having at least one first suction side connected by way of a line segment to the second port and at least one first pressure side assigned to the first suction side;
a first hydraulic connection connects the first port and the output pressure port;
a first valve arranged about the first hydraulic connection, the first valve configured to be open when deenergized and is controllable in an analog manner; and
a second hydraulic connection connects the first port and the second port;
a second valve arranged about the second hydraulic connection, the second valve configured to be closed when deenergized; and
a third valve arranged between the first pressure side of the pump assembly and the first suction side, the third valve is configured to be open when deenergized and is controllable in an analog manner.

13. The brake system of claim 12, further comprising a brake booster arranged upstream of the brake master cylinder.

14. The brake system of claim 12, wherein the brake system comprises another electrically controllable pressure supply device, which is formed by a cylinder-piston assembly, the piston of which can be actuated by an electromechanical actuator, wherein, in a “brake-by-wire” operating mode, the brake system can be controlled either by a vehicle driver or independently of the vehicle driver.

15. The brake system of claim 14, further comprising a first electronic open-loop and closed-loop control unit, assigned to the pressure supply device and the pressure modulation device, and a second electronic open-loop and closed-loop control unit, assigned to the pump-valve assembly.
